(19) United States
(12) Patent Application Publication
(10) Pub. No.: US 2016/0374380 A1
(43) Pub. Date: Dec. 29, 2016

(54) SALTY TASTE ENHANCER

(71) Applicant: T. HASEGAWA CO., LTD., Tokyo (JP)

(72) Inventors: Haruka KINO, KANAGAWA (JP); Masanao KAKUTANI, KANAGAWA (JP); Koichi HATTORI, KANAGAWA (JP); Kuniki KINO, TOKYO (JP)

(73) Assignee: T. HASEGAWA CO., LTD., Tokyo (JP)

(21) Appl. No.: 15/186,720

(22) Filed: Jun. 20, 2016

(30) Foreign Application Priority Data
Jun. 26, 2015 (JP) 2015-128323

(51) Int. Cl. A23L 1/22

(52) U.S. Cl. CPC A23L 27/21; A23L 27/88; A23V 2002/00

(57) ABSTRACT

Provided is a salty taste enhancer that is capable of maintaining the flavor balance inherent in a food and enhancing salty taste despite a reduction in salt content. The salty taste enhancer effectively enhances salty taste by adding to a food or beverage having salty taste at least one selected from the group consisting of prolylglycine, glycylglycine, glycylproline and hydroxyprolylglycine, or a gelatin degradation product containing the dipeptide.

### TECHNICAL FIELD

The present invention relates to a salty taste enhancer. More particularly, the present invention relates to a salty taste enhancer, having as an active ingredient thereof at least one selected from the group consisting of prolylglycine, glycylglycine, glycylproline and 1.0 hydroxyprolylglycine, and to the application of the salty taste enhancer.

### BACKGROUND ART

Salt (sodium chloride) is commonly used in foods and beverages as a seasoning that produces a salty taste and for the purpose of preservation and the like. However, excessive intake of sodium contained in salt has been indicated to be a remote cause of lifestyle diseases such as hypertension, kidney disease or heart disease that have become important social issues in recent years, and therefore foods and beverages having reduced salt contents have been developed. Moreover, in response to a growing awareness of health, low-salt soy sauce, low-salt fermented bean paste and various other foods and beverages having reduced salt contents have been marketed. However, in the case of having reduced salt content, salty taste is naturally diminished resulting in a sense of dissatisfaction. Although potassium chloride or calcium chloride and the like can be used as alternatives for salt, these materials cannot be used without modification due to their peculiar taste and smell. Therefore, for example, technologies have been developed for producing a suitable salty taste despite a low salt content by replacing a portion of salt with potassium chloride to reduce the unpleasant taste of potassium salts (PTL 1 to 6). However, the application of these technologies to actual products has currently not been implemented to a significant degree.

In addition, proposals have also been made regarding the effect of peptides on enhancing salty taste. Examples of the proposals include: a method for enhancing the salty taste of foods and beverages, in which a peptide, obtained by subjecting an acidic peptide or protein to hydrolysis and amide treatment, is added to a salt-containing food or beverage (PTL 7); a salty taste enhancer, obtained by adding a dipeptide containing glutamine to a protein material enzyme degradation product and/or basic amino acid, particularly arginine (PTL 8); a salty taste enhancer containing an enzyme degradation product of an animal protein and an enzyme degradation product of a plant protein (PTL 9), and a bottled soy sauce-containing liquid seasoning, which produces a suitable salty taste and depth of flavor despite a low salt content as it contains specific amounts of sodium and leucylserine (PTL 10).

### CITATION LIST

### Patent Literature

### PTL 1: JP S63-287460 A

### PTL 2: JP H4-262758 A

### PTL 3: JP H11-187841 A

### PTL 4: JP 2008-543332 A

### PTL 5: JP 2009-27974 A

### PTL 6: JP 2010-4767 A

### PTL 7: WO 01/039613

### PTL 8: WO 2009/113563

### PTL 9: WO 2009/119503

### PTL 10: JP 2012-165740 A

### DISCLOSURE OF THE INVENTION

### Technical Problem

Although the various types of agents or compositions proposed regarding the enhancement of salty taste disclosed as prior art or in the above-mentioned citation list are recognized to be effective to a certain degree, they cannot necessarily be said to be satisfactory since, for example, adequate effects are unable to be obtained unless other peptides or protein degradation products are present.

This being the case, if a salty taste enhancer becomes available that is capable of effectively enhancing salty taste by being added to a food or beverage having a salty taste without producing any sense of unpleasantness whatsoever with respect to the inherent flavor of the food or beverage, then this would be useful for enriching technology in the this technical field.

Thus, an object of the present invention is to provide a salty taste enhancer that maintains the flavor balance inherent in a food and enables the sensation of a desired salty flavor by using this enhancer in food having salty flavor despite having reduced the content of the salty taste causative substance, particularly sodium chloride.

### Solution to Problem

As a result of conducting extensive studies on enhancing the salty taste of foods and beverages in which salt content has been reduced, the inventors have found that salty taste is effectively enhanced when at least one type of dipeptide selected from the group consisting of prolylglycine, glycylglycine, glycylproline and hydroxyprolylglycine, or dipeptide derived from a gelatin degradation product, is added as a salty taste enhancer to a food or beverage having a salty taste, and thus have completed the present invention.

Thus, the present invention provides a salty taste enhancer having as an active ingredient thereof at least one selected from the group consisting of prolylglycine, glycylglycine, glycylproline and hydroxyprolylglycine, and an application of the salty taste enhancer.

(1) A salty taste enhancer having as an active ingredient thereof at least one selected from the group consisting of prolylglycine, glycylglycine, glycylproline and hydroxyprolylglycine.

(2) A seasoning for enhancing salty taste containing at least one selected from the group consisting of prolylglycine, glycylglycine, glycylproline and hydroxyprolylglycine in an amount effective for enhancing salty taste.

(3) The seasoning for enhancing salty taste of (2), further containing methionylglycine in an effective amount for enhancing salty taste.

(4) The seasoning for enhancing salty taste of (2), wherein the prolylglycine, glycylglycine, glycylproline and hydroxyprolylglycine are derived from a gelatin degradation product.

(5) The seasoning for enhancing salty taste of (3), wherein the methionylglycine is derived from a gelatin degradation product.

(6) The seasoning for enhancing salty taste of (4) or (5), wherein the gelatin degradation product is an enzyme degradation product.

(7) The salty taste enhancer of (1) or the seasoning for enhancing salty taste of any of (2) to (6), wherein enhancing salty taste is enhancing the salty taste of salt.

(8) A method for enhancing salty taste of a food or beverage containing salt, the method including adding the salty taste enhancer of (1) or the seasoning for enhancing salty taste of any of (2) to (6) to a food or beverage having salty taste.

(9) The method for enhancing salty taste of (8), wherein the food or beverage having salty taste is a low-salt food or beverage.

In addition, the following inventions are provided as other aspects of the present invention.

(10) A method for enhancing salty taste of a food or beverage, the method including: containing an effective amount of at least one type of dipeptide selected from the group consisting of prolylglycine, glycylglycine, glycylproline and hydroxyprolylglycine in a food or beverage for which enhanced salty taste is desired.

(11) The method for enhancing salty taste of (10), wherein the food or beverage for which enhanced salty taste is desired is a low-salt food or beverage.

(12) The method for enhancing salty taste of (10), wherein the dipeptide contains prolylglycine as an essential component.

(13) The method for enhancing salty taste of (10), wherein the dipeptide contains prolylglycine as an essential component, and further contains at least one type of dipeptide selected from the group consisting of glycylglycine, glycylproline, hydroxyprolylglycine and methionylglycine.

(14) The method for enhancing salty taste of (10), wherein the dipeptide contains prolylglycine as an essential component, and further contains methionylglycine as an essential component.

(15) The method for enhancing salty taste of (10), wherein the dipeptide contains prolylglycine, glycylproline, hydroxyproline and methionylproline.

(16) The method for enhancing salty taste of (10), wherein the dipeptide contains prolylglycine, glycylproline, hydroxyproline and methionylproline, and the prolylglycine and glycylproline are present at a weight ratio of 1:35 to 1:240.

(17) The method for enhancing salty taste of (10), wherein the dipeptide is derived from a gelatin degradation product obtained by degradation with a protease.

(18) The method for enhancing salty taste of (10), wherein the dipeptide is derived from a gelatin degradation product obtained by degradation with a protease that is derived from Aspergillus oryzae.

### Effects of the Invention

A food or beverage having a favorable salty taste can be provided that is capable of enhancing salty taste without impairing flavor, even though the content of a salty taste causative substance is low, by adding at least one type of dipeptide selected from the group consisting of prolylglycine, glycylglycine, glycylproline and hydroxyprolylglycine, or as an active ingredient thereof a salty taste enhancer containing the dipeptide derived from a gelatin degradation product, to a food or beverage which has salty taste and in which the content of salt or other salty taste causative substance has been reduced.

### DESCRIPTION OF THE PREFERRED EMBODIMENTS

The following describes the present invention in more detail.

A salty taste causative substance according to the present invention refers to a salt such as salt (sodium chloride), potassium chloride, ammonium chloride, magnesium chloride, potassium malate, magnesium chloride, magnesium sulfate, calcium chloride or calcium lactate. Thus, salty taste refers to a sense of taste that is perceived with the tongue by a person with respect to an aqueous solution of the above-mentioned salt.

In addition, a “salty taste enhancer” may be configured such that it is consumed in the form of any of a solid, such as granules, grains, tablets or powder, liquid or suspension, and may contain other ingredients within a range that does not have a detrimental effect on the object of the present invention.

An “effective amount for enhancing salty taste” or “effective amount for enhancing the salty taste of salt” as referred to in the present invention refers to an amount of either an active ingredient or the above-mentioned dipeptide, or a mixture thereof, which produces a salty taste comparable to the degree of the sense of salty taste for which at least seven expert sensory evaluation panelists perceive a stronger salty taste for a sample obtained by adding at least one type of dipeptide, selected from the group consisting of prolylglycine, glycylglycine, glycylproline and hydroxyprolylglycine, to a concentration of at least 0.05% by weight to saltwater having a concentration of 0.60% by weight, in comparison with a sample to which the above-mentioned dipeptide has not been added, as determined according to a flavor evaluation described in the examples to be subsequently described. Thus, although there are no particular limitations thereon, in the case of containing in a food or beverage that produces a salty taste comparable to saltwater having a concentration of 0.60% by weight, the above-mentioned dipeptide is at least contained at 0.05% by weight, preferably at least 0.10% by weight, and more preferably at least 0.20% by weight, based on the total weight of the food or beverage.

The prolylglycine, glycylglycine, glycylproline, hydroxyprolylglycine and methionylglycine used in the present invention may be synthetic products or extracted from a natural substance and purified. In addition, a degradation product obtained by degrading gelatin with a proteolytic enzyme can be used, or, depending on the situation, a degradation product for which the content of the above-mentioned dipeptide has been enhanced by purification can also be used.

Synthetic products of prolylglycine, glycylglycine, glycylproline, hydroxyprolylglycine and methionylglycine are produced by ordinary chemical synthesis methods, which bond amino groups and carboxyl groups, or by enzymatic synthesis methods. Examples of enzymatic synthesis methods include a synthesis method that uses a microbially derived L-amino acid ligase described in Japanese Patent Application Publication No. 2011-239707.

Although enzymatically synthesized products of dipeptides such as prolylglycine, glycylglycine, glycylproline, hydroxyprolylglycine and methionylglycine preferably exhibit a high purity of a desired dipeptide contained therein, amino acids such as proline, glycine, hydroxyproline or methionine, dipeptides other than the desired dipeptide, and other peptides may also be contained provided the effect of enhancing salty taste is maintained. In addition, synthetic products of prolylglycine, glycylglycine, glycylproline, hydroxyprolylglycine and methionylglycine may be used if necessary after further purifying the same by a method such as ethanol fractionation, membrane filtration, ion exchange chromatography, activated carbon column chromatography, ODS column chromatography, silica gel chromatography or affinity chromatography. As a result of such purification, unnecessary components are removed, strange and unintended tastes are reduced, and salty taste enhancing effects can be demonstrated with smaller added amounts.

A desired dipeptide derived from a gelatin degradation product obtained by degrading gelatin with a protease, or a mixture thereof, may be used for the prolylglycine, glycylglycine, glycylproline, hydroxyprolylglycine and methionylglycine used in the present invention. The mixture can be a mixture of one or more types of dipeptides selected from the group consisting of prolylglycine, glycylglycine, glycylproline and hydroxyprolylglycine with methionylglycine. The mixing ratio of such dipeptides is such that the ratio of the former to the latter is 5001 to 1:1, preferably 2001 to 2:1 and more preferably 1001 to 4:1.

There are no particular limitations on the source of the gelatin in the present invention, and examples thereof include pig skin, pig bone, fish scales, fish skin, beef bone and cowhide.

In the present invention, a gelatin degradation product refers to the product of enzymatically degrading the above-mentioned gelatin into a mixture of amino acids and peptides including the above-mentioned dipeptides. Various types of proteolytic enzymes can be used to degrade gelatin. Effectively, the gelatin is only required to be degraded enzymatically, and may also be degraded by fermentation and the like.

The amount of proteolytic enzyme used when enzymatically degrading gelatin is 0.1% by weight to 10% by weight and preferably 0.2% by weight to 5% by weight based on the weight of the gelatin. Addition of the above-mentioned amounts of proteolytic enzyme to gelatin makes it possible to efficiently degrade the gelatin into a mixture of amino acids and peptides.

Proteases are examples of proteolytic enzymes, and more specific examples include endopeptidases and exopeptidases. These may be used alone or in combination. Examples of endopeptidases include trypsin, chymotrypsin, subtilisin, pepsin, thermolysin, papain and elastase. Examples of exopeptidases include aminopeptidase and carboxylpeptidase. Specific examples of commercially available proteases used as food additives include Alcalase (Novozymes), Neutrase (Novozymes), Flavourzyme (Novozymes), Nucleisin (HBI Enzymes Inc.), Orientase 20A (HBI Enzymes Inc.), Molsin F (Kikkoman Biochemifa Company), Newlase F (Amano Enzyme Inc.), Protease M-SD (Amano Enzyme Inc.), Protease P6G (Amano Enzyme Inc.), Protease P “Amano” 3SD (Amano Enzyme Inc.), Protease P “Amano” 6SD (Amano Enzyme Inc.), Sumizyme MP (SHINNIHON CHEMICALS Corporation), Sumizyme AP (SHINNIHON CHEMICALS Corporation), Sumizyme OP (SHINNIHON CHEMICALS Corporation), Sumizyme FP (SHINNIHON CHEMICALS Corporation), Actinase AS (Kaken Pharma Co., Ltd.) and Kokulase P (Mitsubishi-Kagaku Foods Corporation). In addition, two or more types of these proteolytic enzymes can also be used in combination. These enzymes are preferably reacted with a substrate for 1 hour to 48 hours, and particularly 3 hours to 24 hours, under temperature and pH conditions suitable for each enzyme. Gelatin degradation products obtained in this manner can be used without requiring any modification. In particular, protease preparations (containing suitable ratios of acidic, neutral and alkaline proteases) derived from Aspergillus oryzae such as Kokulase P and usable for foods can be used preferably.

In addition, gelatin degradation products obtained by being subjected to further purification by a method such as ethanol fractionation, membrane filtration, ion exchange chromatography, activated carbon column chromatography, ODS column chromatography, silica gel chromatography or affinity chromatography may also be used. Although purified gelatin degradation products preferably exhibit high purities of prolylglycine, glycylglycine, glycylproline, hydroxyprolylglycine and methionylglycine, they are not limited thereto provided the effect of enhancing salty taste is maintained. As a result of purifying in this manner, unnecessary components are removed, strange and unintended tastes are reduced, and salty taste enhancing effects can be demonstrated with smaller added amounts. As a result, from among gelatin degradation products which are obtained by degradation with proteases and which can be used in the present invention, gelatin degradation products of 1600 daltons, preferably 1400 daltons, and more preferably 1200 daltons or more can be removed.

As a result of adding or containing a salty taste enhancer or the above-mentioned dipeptide-containing preparation obtained according to the above-mentioned methods to or in a food or beverage having salty taste, the salty taste of the food or beverage can be enhanced. Although the contained amount of a salty taste causative substance cannot be specified since the intensity of salty taste varies depending on the person consuming the food or beverage, the food or beverage can preferably be a food or beverage, for which it is desired to enhance salty taste, or a low-salt food. As was previously described, although preference for salty taste varies, a food or beverage for which it is desired to enhance salty taste, or a low-salt food or beverage, generally refers to a food or beverage for persons exhibiting symptoms of hypertension or kidney disease and the like. Such a food or beverage is targeted for consumption by healthy individuals, and can be a food or beverage in which the salt content is reduced by at least 25%, preferably by at least 40% and more preferably by at least 50% in terms of salt in typical commercially available products. In addition, information regarding low-salt foods and beverages can be obtained by referring to the List of Low-Salt Foods disclosed by the Salt Reduction Committee of the Japanese Society of Hypertension that promotes reducing salt intake. As a general reference for the amount of the above-mentioned dipeptide to be added, although varying according to the food or beverage to which it is added, the effect of enhancing salty taste can be demonstrated by adding, for example, the prolylglycine of the present invention at 0.01% by weight to 0.5% by weight and preferably at 0.05% by weight to 0.2% by weight, based on the total weight of the food or beverage having a salty taste based on the content of dipeptide in a food or beverage that produces a salty taste comparable to saltwater having a concentration of 0.60% by weight as previously described.

Thus, the salty taste enhancer of the present invention is able to enhance the salty taste of a food or beverage having salty taste by being added to or contained in a food or beverage having salty taste. By applying the salty taste enhancer of the present invention to a food or beverage having a salty taste, and particularly to low-salt food or beverage in which salt content has been reduced for health reasons, it becomes possible to enhance salty taste effectively while eliminating any sense of dissatisfaction and maintaining and enhancing taste components such as flavor and richness despite the reduction in salt content. In addition, by applying the salty taste enhancer of the present invention to a potassium salt-containing food or beverage in which a portion of the salt has been replaced with potassium chloride, salty taste can be enhanced while reducing the amount of potassium salt used or eliminating the need for the use thereof, improving the unpleasant taste associated with potassium salt-containing foods and beverages, and maintaining and enhancing flavor, richness and the like. Examples of foods and beverages having such salty taste include rice chips, rice crackers and other types of Japanese confections; salt caramels, salt candy, cookies, bread and other types of Western-style confections; rice balls, pilaf, fried rice, mixed rice and vegetables, rice porridge, rice with green tea and other types of rice dishes; potato chips and other types of snacks; flour paste, peanut paste and other types of pastes; pickles, foods boiled in soy sauce and salted foods; ham, hamburgers, sausage, bacon, dried sausage, beef jerky and other types of meat products; fish ham, fish sausage, fish paste, tube-shaped fish cakes, ground fish cakes, tempura and other seafood; instant curry sauce, retort curry sauce, canned curry sauce and other curry products; bean paste, powdered bean paste, soy sauce, powdered soy sauce, unrefined rice wine mash, fish sauce, Worcestershire sauce, pasta sauce, soup, ketchup, mayonnaise, salad dressing, bouillon cubes, steak sauce, curry roux, stew base, soup base, instant bouillon and various other seasonings; and, miso soup, noodle soup, clear broth, consume soup, Chinese noodle soup and potage soup.

In addition, the salty taste enhancer of the present invention may also be used in combination with various types of known, commercially available additives for the purpose of reducing salt content.

The following describes the present invention in further detail with reference to the following examples. Furthermore, the present invention is not limited thereto.

### Example 1

### Salty Taste Enhancing Effect of Dipeptides in Saltwater

Saltwater having a concentration of 0.60% by weight was prepared for use as a model low-salt food or beverage (Comparative Product 1). Saltwater was also prepared by adding commercially available prolylglycine (Funakoshi Co., Ltd.) at a concentration of 0.10% by weight to this 0.60% by weight saltwater (Present Invention Product 1). Similarly, saltwater was also produced by respectively adding commercially available glycylproline (PEPTIDE INSTITUTE, INC.) at 0.10% by weight, commercially available glycylglycine (Tokyo Chemical Industry Co., Ltd.) at 0.05% by weight, or commercially available hydroxyprolylglycine (Funakoshi Co., Ltd.) at 0.05% by weight to 0.60% by weight saltwater. The saltwater to which glycylproline has been added was designated as Present Invention Product 2, the saltwater to which glycylglycine had been added was designated as Present Invention Product 3, and the saltwater to which hydroxyprolylglycine had been added was designated as Present Invention Product 4.

Using Comparative Product 1 as the target of comparison, Present Invention Products 1 to 4 were compared blindly by seven highly trained panelists. Each of the samples was fixed to an amount of 0.5 mL as the amount contained in the mouth each time the samples were tasted, and the salty taste enhancing effects of Present Invention Products 1 to 4 were assessed by selecting the sample perceived by the panelists as having the strongest salty taste. The numbers of panelists who felt that Present Invention Products 1 to 4 produced a strong salty taste are shown in Table 1.

TABLE 1
Salty Taste Enhancing Effects of Dipeptides

| | | | No. of |
|---|---|---|---|
| | | Added | Panelists |
| | | Concentration | who |
| | Dipeptide | (%) | selected/7 |
| Present Invention | Prolylglycine | 0.10 | 7 |
| Product 1 | | | |
| Present Invention | Glycylproline | 0.10 | 4 |
| Product 2 | | | |
| Present Invention | Glycylglycine | 0.05 | 5 |
| Product 3 | | | |
| Present Invention | Hydroxyprolylglycine | 0.05 | 4 |
| Product 4 | | | |

According to the results of Table 1, the addition of dipeptide to a model low-salt food or beverage, which was saltwater having a concentration of 0.60% by weight, exhibited enhancement of salty taste. With respect to prolylglycine in particular, all of the panelists responded that they perceived a strong salty taste in comparison with 0.60% by weight saltwater, and the prolylglycine demonstrated a particularly superior salty taste enhancing effect.

### Example 2

### Concentration Dependency of Salty Taste Enhancing Effect of Prolylglycine

Saltwater was prepared by adding the above-mentioned prolylglycine to the Comparative Product 1 used in Example 1 at a concentration of 0.05% by weight (Present Invention Product 5). Similarly, saltwater was prepared by adding the above-mentioned prolylglycine at concentrations of 0.10% by weight and 0.20% by weight (the saltwater to which the prolylglycine was added at 0.20% by weight was designated as Present Invention Product 6). The samples of Comparative Product 1 and Present Invention Products 1, 5 and 6 were compared completely in the blind, with the amount of the samples being fixed to 0.5 mL as the amount contained in the mouth each time the samples were tasted, and with the samples being subjected to a sensory evaluation by assigning a score of 3 to the sample having the strongest salty taste, assigning a score of 2 to the sample having the next strongest salty taste, assigning a score of 1 to the sample having the next strongest salty taste after that, and assigning a score of 0 to the sample having the weakest salty taste. The sensory evaluations were performed by seven panelists and enhancement of salty taste was evaluated based on the total score for each sample. The total scores of the seven panelists along with the average flavor evaluations are shown in Table 2.

TABLE 2
Salty Taste Enhancing Effects of Saltwater

| | Prolylglycme | | |
|---|---|---|---|
| | concentration | Total | |
| | (%) | score | Flavor evaluation |
| Comparative | 0.00 | 2 | Salty taste not very strong |
| Product 1 | | | |
| Present Invention | 0.05 | 5 | Salty taste enhanced more than |
| Product 5 | | | Comparative Product 1 |
| Present Invention | 0.10 | 16 | Salty taste enhanced more than |
| Product 1 | | | Convention Product 1 |
| Present Invention | 0.20 | 19 | Strongest salty taste in |
| Product 6 | | | comparison with other samples |

According to the results of Table 2, the addition of prolylglycine to a model low-salt food or beverage, which was saltwater having a concentration of 0.60% by weight, exhibited enhancement of salty taste. In addition, as a result of comparing the total scores, it was shown that the salty taste enhancing effect of prolylglycine becomes stronger concentration-dependently.

### Example 3

### Salty Taste Enhancing Effects of Combined Use of Dipeptides

Saltwater was prepared by adding the above-mentioned prolylglycine at 0.10% by weight and adding the above-mentioned glycylglycine at 0.10% by weight to the Comparative Product 1 used in Example 1 (Present Invention Product 7). Similarly, saltwater was prepared by adding the above-mentioned prolylglycine at 0.10% by weight and the above-mentioned glycylproline at 0.10% by weight (Present Invention Product 8), and saltwater was prepared by adding the above-mentioned prolylglycine at 0.10% by weight and adding the above-mentioned hydroxyprolylglycine at 0.10% by weight (Present Invention Product 9).

Using Comparative Product 1 as the target of comparison, the Present Invention Products 7 to 9 were compared blindly by seven highly trained panelists. Each of the samples was fixed to an amount of 0.5 mL as the amount contained in the mouth each time the samples were tasted, and the salty taste enhancing effects of Present Invention Products 7 to 9 were assessed by selecting the sample perceived by the panelists as having the strongest salty taste. The numbers of panelists who felt that Present Invention Products 7 to 9 produced a strong salty taste are shown in Table 3.

TABLE 3
Salty Taste Enhancing Effects of Combined Use of Dipeptides

| | | No. of Panelists |
|---|---|---|
| | | who selected/7 |
| Present Invention | Combination of prolylglycine | 7 |
| Product 7 | and glycylglycine | |
| Present Invention | Combination of prolylglycine | 6 |
| Product 8 | and glycylpyoline | 6 |
| Present Invention | Combination of prolylglycine | 6 |
| Product 9 | and hydroxyprolylglycine | |

According to Table 3, the addition of a combination of dipeptides to a model low-salt food or beverage, which was saltwater having a concentration of 0.60% by weight, exhibited enhancement of salty taste. With respect to the combination of prolylglycine and glycylglycine in particular, all of the panelists responded that salty taste was enhanced in comparison with 0.60% by weight saltwater, and the combination of prolylglycine and glycylglycine demonstrated a particularly superior salty taste enhancing effect.

### Reference Example 1

### Salty Taste Enhancing Effect of Methionylglycine

Saltwater was prepared by adding commercially available methionylglycine (Tokyo Chemical Industry Co., Ltd.) to the Comparative Product 1 used in Example 1 at a concentration of 0.05% by weight. Similarly, saltwater was prepared by adding the above-mentioned methionylglycine at concentrations of 0.10% by weight and 0.20% by weight to the 0.60% by weight saltwater. Samples of the above-mentioned four products were compared completely in the blind, with the amount of the samples being fixed to 0.5 mL as the amount contained in the mouth each time the samples were tasted, and with the samples being subjected to a sensory evaluation by assigning a score of 3 to the sample having the strongest salty taste, assigning a score of 2 to the sample having the next strongest salty taste, assigning a score of 1 to the sample having the next strongest salty taste after that, and assigning a score of 0 to the sample having the weakest salty taste. The sensory evaluations were performed by five panelists and enhancement of salty taste was evaluated based on the total score for each sample. The total scores of the five panelists along with the average flavor evaluations are shown in Table 4.

TABLE 4
Salty Taste Enhancing Effects of Saltwater

| Met-Gly | | |
|---|---|---|
| concentration | Total | |
| (%) | score | Flavor evaluation |
| 0.00 | 3 | Salty taste not very strong |
| 0.05 | 7 | Salty taste enhanced more |
| | | than Comparative Product 1 |
| 0.10 | 8 | Salty taste enhanced more |
| | | than Convention Product 1 |
| 0.20 | 12 | Strongest salty taste in |
| | | comparison with other samples |

According to the results of Table 4, the addition of methionylglycine to a model low-salt food or beverage, which was saltwater having a concentration of 0.60% by weight, exhibited enhancement of salty taste. In addition, as a result of comparing the total scores, it was shown that the salty taste enhancing effect of methionylglycine becomes stronger concentration-dependently.

### Example 4

### Salty Taste Enhancing Effects of Combined Use of Dipeptide and Methionylglycine

Saltwater was prepared by adding the above-mentioned prolylglycine at 0.20% by weight to Comparative Product 1 used in Example 1 (Present Invention Product 6). Similarly, saltwater was prepared by adding methionylglycine (Tokyo Chemical Industry Co., Ltd.) at 0.20% by weight (Comparative Product 2). In addition, saltwater was prepared by adding the above-mentioned prolylglycine at 0.10% by weight and the above-mentioned methionylglycine at 0.10% by weight (Present Invention Product 10). Present Invention Products 6 and 10 as well as Comparative Product 2 were compared blindly by seven highly trained panelists. The amount of the samples was fixed to an amount of 0.5 mL as the amount contained in the mouth each time the samples were tasted, and the sample having the strongest salty taste was selected from among Present Invention Products 6 and 10 and Comparative Product 2.

As a result, four of the seven panelists evaluated Present Invention Product 10 as having the strongest salty taste. Accordingly, the addition of methionylglycine to prolylglycine was observed to demonstrate a synergistic effect on enhancement of salty taste.

### Example 5

### Production of Pig Gelatin Degradation Product

200 g of Pig Gelatin INA-S2 (Nitta Gelatin Inc.) were added to 450 g of soft water heated to 45° C. to 50° C. followed by adjusting to the optimum pH of the enzyme reaction with a pH adjuster. 5 g of Kokulase P (Mitsubishi-Kagaku Foods Corporation) were added thereto followed by adding soft water and carrying out the enzyme reaction at a temperature of 45° C. to 65° C. 300 g of the Pig Gelatin INA-S2 were added during the enzyme reaction and the enzyme reaction was carried out for 4 hours in total. Following completion of the enzyme reaction, the pH was adjusted to 5.5 and the enzyme was deactivated under conditions of a temperature of about 90° C. for 10 minutes followed by cooling to prepare a pig gelatin degradation product. This was designated as Present Invention Product 11.

### Example 6

### Production of Fish Gelatin Degradation Product

200 g of Fish Gelatin AF-250 (JELLICE) were added to 450 g of soft water heated to 45° C. to 50° C. followed by adjusting to the optimum pH of the enzyme reaction with a pH adjuster. 5 g of Kokulase P (Mitsubishi-Kagaku Foods Corporation) were added thereto followed by adding soft water and carrying out the enzyme reaction at a temperature of 45° C. to 65° C. 300 g of the Fish Gelatin AF-250 were added during the enzyme reaction and the enzyme reaction was carried out for 4 hours in total. Following completion of the enzyme reaction, the pH was adjusted to 5.5 and the enzyme was deactivated under conditions of a temperature of about 90° C. for 10 minutes followed by cooling to prepare a fish gelatin degradation product. This was designated as Present Invention Product 12.

### Example 7

### Quantification of Dipeptides in Gelatin Degradation Products

The contents of prolylglycine, glycylproline, hydroxyprolylglycine and methionylglycine in Present Invention Products 11 and 12 were measured by HPLC. The measurement results are shown in Table 5.

[Measurement of Dipeptides by HPLC]

### Preparation of Standard Solutions

Approximately 50 mg aliquots of prolylglycine, glycylproline, hydroxyprolylglycine and methionylglycine standards were accurately weighed in 100 mL volumetric flasks and diluted in measuring cylinders to a volume of 100 mL with 0.01 N aqueous hydrochloric acid solution followed by suitably precisely diluting with distilled water to prepare standard solutions.

### Preparation of HPLC Measurement Samples

Approximately 0.1 g of Present Invention Product 11 and Product 12 were accurately weighed in a 10 mL volumetric flask and diluted in a measuring cylinder to a volume of 10 mL with distilled water followed by filtering with a PVDF membrane filter (Merck Millipore Corporation, pore size: 0.45 μm). This preparation was used for HPLC analysis.

### HPLC Analysis Conditions

### Instrument: Shimadzu Prominence (Shimadzu Corporation)

### Column: ODS-80TM (TOSOH CORPORATION)

Inner diameter 4.6 mm×length 250 mm
Column temperature: 40° C.
Mobile phase: Liquid A 10 mM phosphate buffer (pH 6.9)

### Liquid B Acetonitrile

Gradient conditions: (A):(B)=95:5 (0 min) to 50:50 (40 min)
Flow rate: 1.0 mL/min
Injection volume: 10 μL
Measuring time: 40 min
Detector: Fluorescence detector, RF-20AXS
Detection conditions: Dual wavelength measurement mode

### ch1: Ex 350 nm, Em 460 nm

### ch2: Ex 266 nm, Em 305 nm

TABLE 5
Dipeptide Analysis Results

| | (w/v%) | |
|---|---|---|
| | Pig Gelatin | Fish Gelatin |
| | Degradation | Degradation |
| Dipeptide | Product | Product |
| Prolylglycine | 0.018 | 0.093 |
| Glycylproline | 4.123 | 3.875 |
| Hydroxyprolylglycine | 0.020 | 0.016 |
| Methionylglyeine | 0.044 | 0.995 |

According to the results of Table 5, Present Invention Products 11 and 12 were shown to contain dipeptides having salty taste enhancing effects, and glycylproline in particular was shown to be contained in large amounts.

### Example 8

### Salty Taste Enhancing Effects of Gelatin Degradation Products

Saltwater was prepared by adding Present Invention Product 11 to Comparative Product 1 used in Example 1 at a concentration of 0.10% by weight (Present Invention Product 13). In addition, saltwater was prepared by adding Present Invention Product 12 to Comparative Product 1 used in Example 1 at a concentration of 0.10% by weight (Present Invention Product 14).

Using Comparative Product 1 as the target of comparison, Present Invention Products 13 and 14 were compared blindly by 18 highly trained panelists. Each of the samples was fixed to an amount of 0.5 mL as the amount contained in the mouth each time the samples were tasted, and the salty taste enhancing effects of Present Invention Products 13 and 14 were assessed by selecting the sample perceived by the panelists as having the strongest salty taste. The results are shown in Table 6.

TABLE 6
Salty Taste Enhancing Effects of Gelatin Degradation
Products

| | | No. of Panelists |
|---|---|---|
| | | who selected/18 |
| Present Invention Product 13 | Pig gelatin | 14 |
| Present Invention Product 14 | Fish gelatin | 13 |

According to the results of Table 6, the addition of gelatin degradation products to a model low-salt food or beverage, which was saltwater having a concentration of 0.60% by weight, exhibited enhancement of salty taste.

### Example 9

### Effect of Enhancing Salty Taste of Low-Salt Chinese Soup

Low-salt Chinese soup was prepared by adding the above-mentioned prolylglycine to commercially available low-salt Chinese soup (salt content: 0.6% by weight) (Comparative Product 3) at a concentration of 0.10% by weight (Present Invention Product 15). Similarly, low-salt Chinese soup was also prepared by adding the above-mentioned prolylglycine at 0.10% by weight and the above-mentioned methionylglycine at 0.10% by weight to Comparative Product 3 (Present Invention Product 16). Moreover, low-salt Chinese soup in which Present Invention Product 11 was added to Comparative Product 3 at a concentration of 0.10% by weight (Present Invention Product 17), and low-salt Chinese soup in which Present Invention Product 12 was added to Comparative Product 3 at a concentration of 0.10% by weight (Present Invention Product 18), were also respectively prepared.

Using Comparative Product 3 as the target of comparison, Present Invention Products 15 to 18 were compared blindly by seven highly trained panelists. Each of the samples was fixed to an amount of 0.5 mL as the amount contained in the mouth each time the samples were tasted, and the salty taste enhancing effects of Present Invention Products 15 to 18 were assessed by selecting the sample perceived by the panelists as having the strongest salty taste. The results are shown in Table 7.

TABLE 7
Effect of Enhancing Salty Taste of Low-Salt Chinese Soup

| | | No. of Panelists |
|---|---|---|
| | Added sample | who selected/7 |
| Present Invention | Prolylglycine | 7 |
| Product 15 | | |
| Present Invention | Prolylglycine + methionylglycine | 7 |
| Product 16 | | |
| Present Invention | Pig gelatin degradation product | 6 |
| Product 17 | | |
| Present Invention | Fish gelatin degradation product | 6 |
| Product 18 | | |

According to the results of Table 7, the addition of dipeptides and gelatin degradation products to commercially available low-salt Chinese soup exhibited enhancement of salty taste.

1. A method for enhancing salty taste of a food or beverage, the method comprising: containing an effective amount of at least one type of dipeptide selected from the group consisting of prolylglycine, glycylglycine, glycylproline and hydroxyprolylglycine in a food or beverage for which enhanced salty taste is desired.

2. The method for enhancing salty taste according to claim 1, wherein the food or beverage for which enhanced salty taste is desired is a low-salt food or beverage.

3. The method for enhancing salty taste according to claim 1, wherein the dipeptide contains prolylglycine as an essential component.

4. The method for enhancing salty taste according to claim 1, wherein the dipeptide contains prolylglycine as an essential component, and further contains at least one type of dipeptide selected from the group consisting of glycylglycine, glycylproline, hydroxyprolylglycine and methionylglycine.

5. The method for enhancing salty taste according to claim 1, wherein the dipeptide contains prolylglycine as an essential component, and further contains methionylglycine as an essential component.

6. The method for enhancing salty taste according to claim 1, wherein the dipeptide contains prolylglycine, glycylproline, hydroxyproline and methionylproline.

7. The method for enhancing salty taste according to claim 1, wherein the dipeptide contains prolylglycine, glycylproline, hydroxyproline and methionylproline, and the prolylglycine and glycylproline are present at a weight ratio of 1:35 to 1:240.

8. The method for enhancing salty taste according to claim 1, wherein the dipeptide is derived from a gelatin degradation product obtained by degradation with a protease.

9. The method for enhancing salty taste according to claim 1, wherein the dipeptide is derived from a gelatin degradation product obtained by degradation with a protease that is derived from Aspergillus oryzae.
